(19) United States
(12) Patent Application Publication
(10) Pub. No.: US 2003/0218288 A1
(43) Pub. Date: Nov. 27, 2003

(54) Machining operations automatic positioning system

(76) Inventor: Xuesong Zhang, Cape Girardeau, MO (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 10/154,017

(22) Filed: May 23, 2002

(51) Int. Cl. B25B 1/22

(52) U.S. Cl. 269/75

(57) ABSTRACT

A workpiece coordinate positioning system and method for use with a workpiece holding apparatus comprising a workpiece tracking system and a workpiece positioning system between which a workpiece is secured. Movement of the workpiece during clamping or machining operations is observed through the workpiece tracking system. The workpiece positioning system is configured with a drive mechanism utilized to compensate for the observed movements, maintaining the workpiece in a predetermined positions and orientation.

### CROSS-REFERENCE TO RELATED APPLICATIONS

None.

### STATEMENT REGARDING FEDERALLY SPONSORED RESEARCH

Not Applicable.

### BACKGROUND OF THE INVENTION

The present invention sets forth a system for accurately positioning an object in three dimensional space, and more particularly, to a workpiece coordinate positioning system configured to both measure and adjust the position of a workpiece secured in a workpiece holding apparatus.

Rapid acquisition of digital data accurately representing the position and orientation of an object in three dimensional space has always been a problem during machining processes in the machining industry. One method of obtaining dense and accurate digital data representing these parameters for an object or workpiece is through the use of a coordinate measuring machine (commonly known as a “CMM's”). CMM's translate and rotate a sensor probe into contact with the surface of an object undergoing testing to sample the position of various points on the object's surface. CMM's provide dense measurements of the sample points. However, the time to scan an object is relatively slow as the sensor probe must be continually repositioned. Once the dense surface points are collected, software processes these points into deviations from a computer assisted drawing (CAD) model and analyzes the deviations in terms of variations from a desired position and orientation. Current CMM processing software, however, is also relatively slow.

An alternate method for obtaining data on these parameters, where speed is of importance, is to employ hard gauging using micrometers, calipers and shims. In hard gauging, an object undergoing measurement is placed in close proximity to a set of molds or forms which are configured to exactly match the desired position and orientation parameters. Comparisons are then made between the surfaces of the object undergoing measurement and the set of molds or forms using the mechanical gauges and calipers to obtain measurements of any deviations from the desired object position. This hard gauging is costly, as a new set of molds or forms must be machined for each object undergoing testing and are inflexible to change. While hard gauging is fast, it does not provide dense measurement data, providing, instead, only individual measurements at a relatively few defined contact points.

Yet another method of obtaining measurements representing position and orientation parameters of an object is with full-field non-contact range sensors. Non-contact full-field sensors can scan the external surfaces of opaque objects, using laser or white light, significantly faster than CMMs. While these sensors are capable of scanning the part quickly and obtain large quantities of data, the level of accuracy from commercially available range sensors is significantly lower than that CMMs. Examples of non-contact sensors include sensors that are based on laser line grating and stereo triangulation, and those based on single laser line scan plus rotation of the object. Additional non-contact sensors are based on phase-shifted Moiré patterns and white light.

Currently, there is a need for a system which is capable of obtaining accurate high-speed measurements of the position and orientation of an object to allow for the objection to be placed or moved to a desired position and orientation. Furthermore, there is a need for the system to be capable of being rapidly reconfigured to measure one or more differently shaped objects without the need for replacement components.

### BRIEF SUMMARY OF THE INVENTION

Briefly stated, the present invention is related to a workpiece coordinate positioning system for use with workpiece holding apparatus to position a workpiece in three dimensional space. The workpiece coordinate position system includes three main components. A workpiece position sensing system is configured to detect the position and orientation of a workpiece in three-dimensional space, a workpiece positioning system which is adapted to position the workpiece in a predetermined position and orientation in three-dimensional space and a workpiece holding system adapted to releasably hold the workpiece in the predetermined position and orientation during a machining process. The workpiece positioning system and workpiece holding system cooperatively operate to monitor and correct for changes in the position and orientation of the workpiece from the predetermined position and orientation established by the workpiece positioning system during a clamping or machining process. Alternatively, each of the components of the workpiece coordinate positioning system may be utilized independently to enhance or improve the operation of a conventional machining system

The present invention provides a computer controlled positioning system capable of automatically positioning a workpiece or object within a vice. The three-dimensional position and orientation of the object is determined and adjusted as required utilizing the same components. The workpiece coordinate positioning system of the present invention is adaptable to conventional workpiece holding systems utilizing conventional vices. However, the present invention is particularly suited for use with workpiece holding systems utilizing magnetorheological fluid workpiece holding devices.

The workpiece coordinate positioning system of the present invention is adaptable to quickly and accurately position a wide range of machine parts (i.e. workpieces or objects), which may be both regularly shaped as well as irregularly shaped.

The foregoing and other objects, features, and advantages of the invention as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a perspective view of one embodiment of the workpiece coordinate position system of the present invention;

FIG. 2 is a perspective illustration of a first embodiment of a tracking device;

FIG. 3 is a simplified perspective illustration of the internal components of the tracking device of FIG. 2;

FIG. 4 is a perspective illustration of a second embodiment of a tracking device;

FIG. 5 is a perspective illustration of an embodiment of a workpiece positioning device of the present invention showing the cylindrical vice platform and vice base; and

FIG. 6 is a perspective illustration of the workpiece positioning device of FIG. 5, showing the cylindrical vice platform and rotational table.

Corresponding reference numerals indicate corresponding parts throughout the several figures of the drawings.

### DESCRIPTION OF THE PREFERRED EMBODIMENT

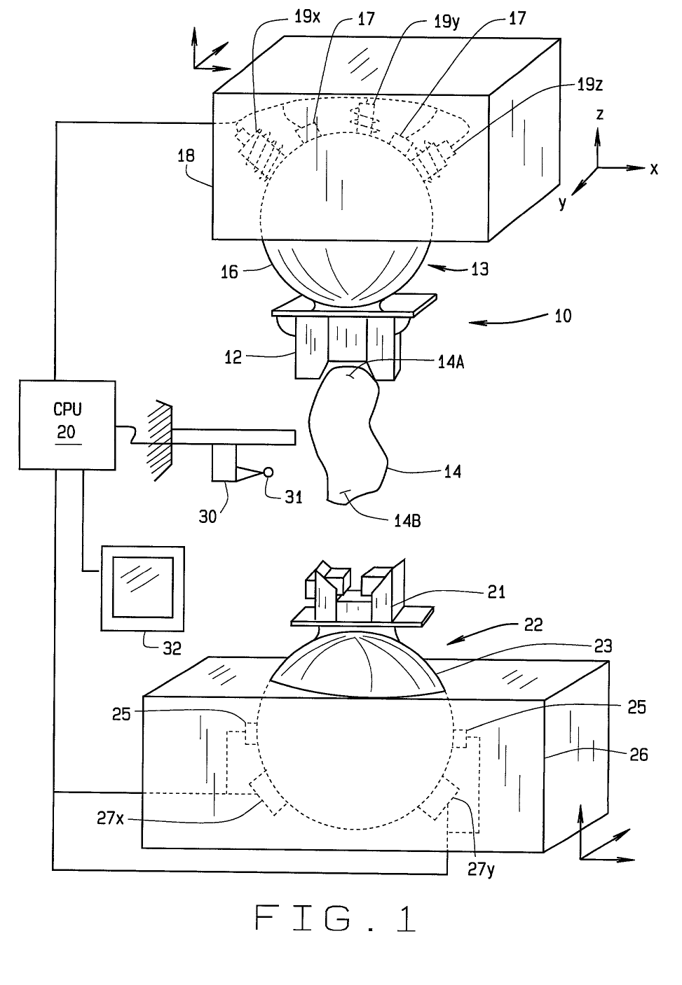

Turning to FIG. 1, one embodiment of the workpiece coordinate positioning system of the present invention is shown generally at 10. A first workpiece positioning arm 12 is adapted to conventionally engage and secure a workpiece 14 by an upper surface 14A. The workpiece positioning arm 12 is secured to a tracking device 13 capable of measuring displacement (i.e. movement and rotation) in three-dimensional space.

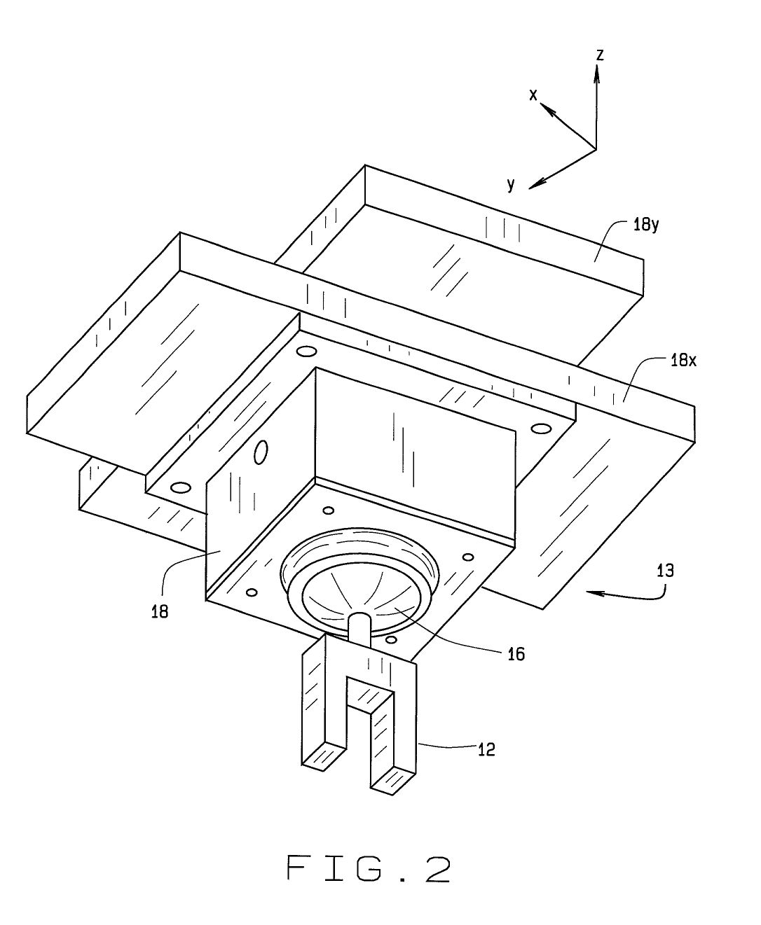

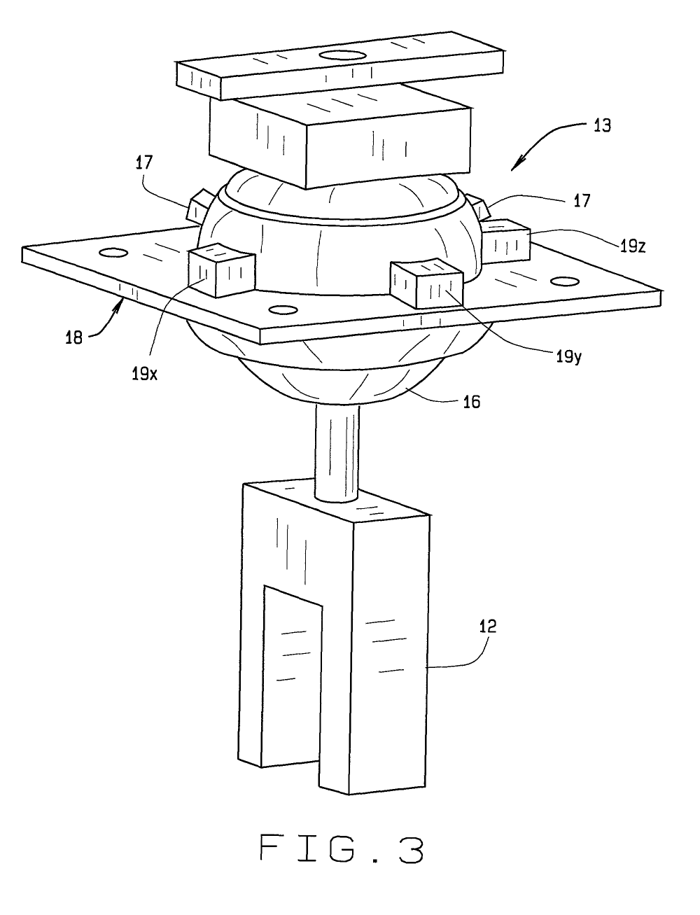

In a first embodiment, as seen in FIGS. 2 and 3, the tracking device 13 comprises a top trackball 16, adapted for rotational movement with three degrees of freedom, i.e. rotation about three perpendicular axis denoted X, Y, and Z. The top trackball 16, composed of a solid and durable material, such as steel, is partially encapsulated and secured within a conventional X, Y, Z tracking system 18 capable of movement along each axis. For example, to measure movement in the X and Y planes, the tracking system 18 includes two plates 18X and 18Y, which are configured for perpendicular movement relative to each other, along either the X-axis or the Y-axis. Other conventional systems for tracking controlled movement in two- or three-dimensional space may be employed.

The tracking device 13 is configured to measure axial movement in three dimensions and includes at least two conventional sensors 17 in engagement with the top trackball 16 adapted to track rotational movement of the trackball 16. For example, these conventional sensors 17 may each consist of a rotary encoder in frictional contact with the surface of the top trackball 16, such that rotational movement of the top trackball is detected as rotation movement in each of the conventional rotary sensors 17. Preferably, each conventional rotary sensor 17 is adapted to detect rotational movement of the top trackball 16 orthogonal to the other. Signals generates by the conventional rotary sensors 17 are communicated to a general purpose computer 20, described below, for subsequent processing.

A set of locking solenoids 19X, 19Y, and 19Z contained within the X, Y, Z, tracking device 13 are positioned in engagement with the top trackball 16. Each locking solenoid 19X, 19Y, and 19Z is configured to secure the top trackball 16 against movement about one axis when an electrical current is applied thereto. The locking mechanism uses the solenoids 19X, 19Y, and 19Z, controlled by the general purpose computer 20, to lock the track-ball 16 in a secure position or to free it for rotational movement about each independent axis X, Y, or Z. i.e. applying or releasing a large holding pressure on the top trackball 16. Additional conventional locking elements, not shown, may be incorporated to secure the tracking system 18 against axial movement along the X, Y, or Z axis. The top trackball 16 and workpiece positioning arm 12 function to provide position change information.

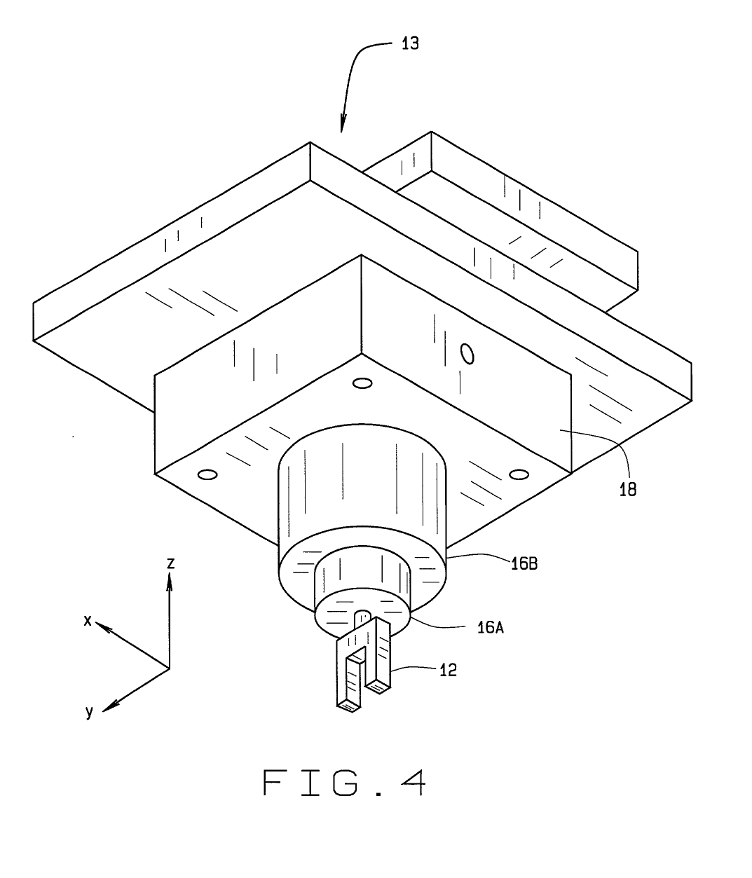

In an alternate embodiment, shown in FIG. 4, the track-ball 16 is replaced by a pair of concentric cylindrical elements 16A and 16B secured within the conventional X, Y, Z tracking system 18. The workpiece positioning arm 12, is secured to cylindrical element 16A. Cylindrical element 16A is configured for rotational movement about an axis concentric with cylindrical element 16B, and both cylindrical elements 16A, 16B are configured for movement along the Z-axis. Movement along each axis, and rotational movement of cylindrical element 16A is measured using conventional displacement sensors, such as optical rotary encoders or linear displacement sensors, which are secured within the tracking device 13 in operative relationship to the observed components. Signals generated by the conventional displacement sensors are communicated to a general purpose computer 20, described below, for subsequent processing. Each cylindrical element 16A, 16B, and the conventional X,Y,Z, tracking system is configured with one or more locking solenoids which may be actuated to secure the associated components against relative movement.

Returning to FIG. 1, a workpiece holding vice 21 is located in proximity to the workpiece positioning arm 12. The workpiece holding vice is mounted to a positioning device 22 and is adapted to releasably secure the workpiece 14 by a lower surface 14B during a machining process such as milling, measuring, or grinding. In one embodiment of the present invention, the workpiece holding vice 21 comprises a magnetorheological fluid vice, such as is set forth in either U.S. Pat. No. 6,267,364 or U.S. Pat. No. 6,182,954. Alternatively, the workpiece holding vice 21 comprises a conventional mechanical vice.

As seen in FIG. 1, the workpiece holding vice 21 is secured to the positioning device 22. In one embodiment, the positioning device 22 includes a bottom trackball 23, adapted to permit movement of the workpiece holding vice 21 in three dimensional space. The bottom trackball 23, composed of a solid and durable material, such as steel, is partially encapsulated within a second conventional X, Y, Z tracking system 26. The second tracking system 26 is configured for movement in three dimensional space along each axis, and includes at least two conventional sensors 25 in engagement with the bottom trackball 23 adapted to track rotational movement of the bottom trackball 23 in the same manner as conventional sensors 17. Through the conventional rotational sensors 25 and one or more axial displacement sensors (not shown), the second conventional tracking system 26 is capable of tracking and recording displacement (i.e. movement and rotation) of the positioning device 22 and workpiece holding vice 21 in three dimensional space as the workpiece is secured by the workpiece holding vice 21.

In the embodiment shown in FIG. 1, a set of two drive motors or solenoids 27X and 27Y are positioned in engagement with the bottom trackball 22, preferably orthogonally to each other. Each drive motor 27X and 27Y is configured to rotate the bottom trackball 22 about a corresponding axis when an electrical current is applied thereto. One drive motor 27X preferably controls the rotation of the track ball 22 about the horizontal axis X, and the other drive motor 27Y preferably controls the rotation of the track ball 22 about the orthogonal vertical axis Y. The combination of movements about the X and Y axis permits the location of the bottom trackball 22 and workpiece holding vice 21 to any desired rotational orientation within the mechanical limitations of the apparatus 10. Correspondingly, axial movement of the entire positioning device 22 permits the location of the bottom trackball 22 and workpiece holding vice 21 to any desired position, within the mechanical limitations of the apparatus 10. In one embodiment of the present invention, the workpiece holding vice 21 and the bottom trackball 22 can move through 360 degrees of rotation about the Y axis and approximately 180 degrees of rotation about the X axis.

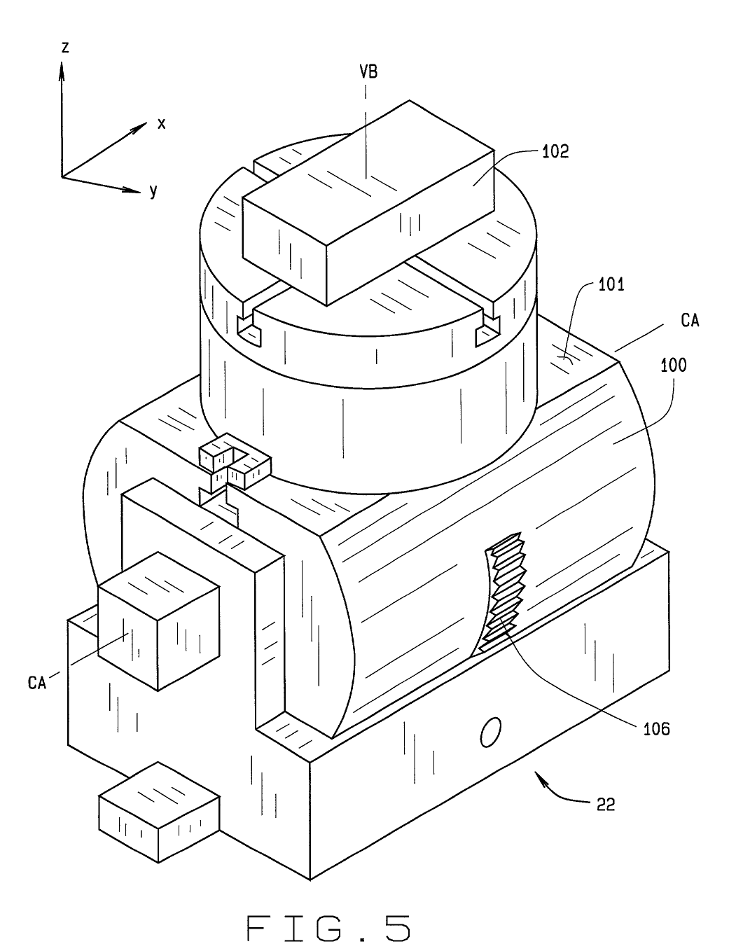

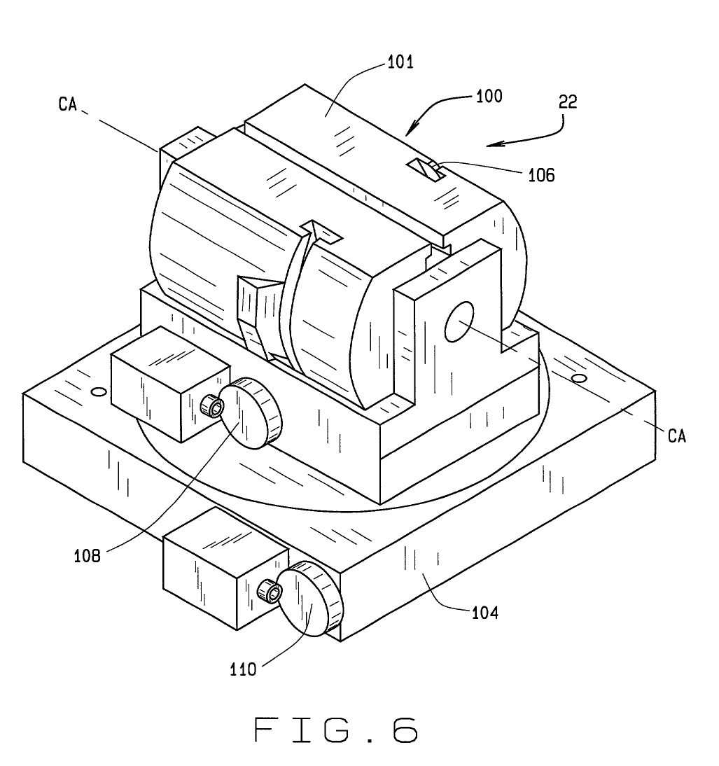

In a preferred embodiment, shown in FIGS. 5 and 6, the positioning device 22 comprises a cylindrical vice platform 100 having a flat face 101 parallel to the cylindrical axis CA, supporting a vice base 102 upon which workpiece holding vice 21 is secured. The cylindrical vice platform 100 is secured for rotational movement at each end, and is adapted for more than 180 degrees of rotation about axis CA, orientated perpendicular to the Z-axis. The vice base 102, mounted to the cylindrical vice platform 100 is adapted for rotational movement about an axis VB perpendicular to axis CA about which the cylindrical vice platform 100 is rotating. Optionally, the vice base 102 is further adapted for lateral movement in a plane parallel to axis CA about which the cylindrical vice platform 100 is rotating. The cylindrical vice platform 100 is, in turn, secured to the top of a conventional translation and rotation table 104 configured for 360 degree rotation in the X-Y plane, as well as movement along each of the respective axis X, Y, and Z.

With this configuration, a workpiece 14 having a longitudinal axis which is secured in the workpiece holding vice 21 may be located at a desired position and orientation within a large volume of three dimensional space. For example, a workpiece 14 may be initially secured in the workpiece holding vice 21 an upright position, such that the workpiece longitudinal axis corresponds with on the Z-axis. The translation and rotation table 104 may be utilized to shift the workpiece 14 along the X and Y axis, and to raise or lower the workpiece along the Z axis. Rotation of the cylindrical vice platform 100 permits the tilting of the workpiece 14 about an arc having greater than 180 degrees of rotation, while rotation of the vice base 102 permits the workpiece to be rotatated about its own longitudinal axis. Those of ordinary skill in the art will recognize that the mechanical limitations imposed on the position and orientation of the workpiece 14 by the apparatus 10 are related to the dimensions of the components utilized and the supporting structures.

Mechanical controlled movement of each component of the positioning device 22 along or about a respective axis is either actuated manually by an operator, or under control of computer 20. Those of ordinary skill in the art will recognize that a wide variety of conventional drive mechanisms, including, but not limited to, ring gears, linear gears, sprockets, worm-drives, and electric motors may be utilized to mechanically control movement of one or more of the components of the positioning device 22 along or about a respective axis, to thereby position the workpiece holding vice 21 at a desired position and orientation in three-dimensional space.

For example, as seen in FIG. 5, a linear gear 106 disposed on the outer surface of the cylindrical vice platform 100 may be in engagement with a motor-driven worm 108 to provide controlled rotational movement about axis CA. Similarly, a second motor-driven worm 110 may be disposed in engagement with a circumferential gearing internal to the rotation table 104, to provide for controlled rotational movement thereof about the Z axis.

It will be noted that sensors for detecting movement of the positioning device 22 in the Z-direction, and mechanisms for providing controlled movement of the positioning device 22 in the Z-direction are not required for most applications. It has been observed that during the clamping process, in which a workpiece 14 is secured within the workpiece holding vice 21, movement in the Z-direction is within negligible tolerances. It will, however, be recognized that in some applications it may be necessary to provide for controlled movement of the positioning device 22 in the Z-direction, and as such, a conventional linear displacement sensor and mechanism for movement along the Z-axis may be provided within the scope of this invention.

The general purpose computer 20 is linked to both the first tracking system 18 and the second tracking system 26. The computer 20 is configured with suitable software to receive and analyze displacement (i.e. movement and rotation) signals received from each of the tracking systems 18, 26, to thereby observe and record movement of each tracking system 18, 26 components in three dimensional space. The general purpose computer 20 is further linked to the locking solenoids or other locking components to provide control signals to direct the locking solenoids or other locking components to secure or release the tracking device 13 for movement about one or more axis, and to the drive motors or solenoids to provide control signals for actuating rotational movement of the tracking device 13 about one or more axis. In addition, the computer 20 is configured to direct axial displacement and rotation of each of the tracking systems 18, 26 in three dimensional space within the mechanical limitations of the apparatus 10. In this manner, the computer 20 can accurately measure the position and orientation of the tracking device 13 and the positioning device 22 in three-dimensional space, and accordingly, the position and orientation of a secured workpiece 14.

To further facilitate the positioning and orientation of the workpiece 14 within three dimensional space to the desired position and orientation for a machining process, a conventional multi-points datum device 30 is operatively connected to, and under control of, the computer 20. The multi-points datum device 30 includes a probe 31 adapted to for accurate controlled movement in three-dimensional space. Under control of computer 20, the probe 31 can be accurately positioned at a predetermined location in three dimensional space to define a reference position for one or more points on the surface of workpiece 14, as will be described below in more detail.

A method for using the workpiece coordinate positioning system of the present invention may be utilized with either regular or irregularly shaped workpieces. Initially, workpiece 14 is secured by an upper surface 14A to the workpiece positioning arm 12. At this point, the components of the first tracking system 18 are free to move in three-dimensional space. Next, a multi-points datum device 30 in communication with the computer 20 is moved to provide a reference position and orientation for the workpiece 14. The components of the first tracking system 18 are moved to position the workpiece 14 at the reference position and orientation. Movement of the multi-point datum device 30 is predetermined, and is preferably directed by software instructions received from the computer 20. The predetermined reference position and orientation is associated with the specific shape and features of the workpiece 14 undergoing machining. Those of ordinary skill in the art will readily recognize that different workpieces may be placed in various positions and orientations within the mechanical limitations of the apparatus 10 by the multi-point data device 30, as is required.

Next, the workpiece positioning arm 12 is reversibly moved along an axis towards the workpiece holding vice 21, such that the lower portion 14B of the workpiece 14 seats within the workpiece holding vice 21. Alternatively, the workpiece holding vice and supporting structure is moved along an axis towards the workpiece positioning arm 12. The workpiece holding vice 21 is then clamped to the workpiece 14, securing it. For regularly shaped workpieces 14, workpiece holding vice 21 is preferably a conventional vice, while for irregularly shaped parts, it is preferably a magnetorheological fluid vice. Prior to the actual clamping of the workpiece 14 in the workpiece holding vice 21, all coordinate values from the upper and lower tracking systems are set to an initial value, preferably zero.

Any displacement and/or rotational movement of the workpiece 14 during the clamping process is tracked by the displacement sensors observing movement of the components of the first tracking system 18, still in an unlocked state.

The tracked movements of the workpiece 14 during the clamping process are recorded by the computer 20. The computer 20 utilizes the recorded movements of the workpiece 14 to facilitate the use of the positioning system 22 to reposition the workpiece 14, by driving the associated workpiece holding vice 21, back to the initial position and orientation of the workpiece prior to the initiation of the clamping process. This repositioning process may be directed manually by a machine operator observing movement values presented on a display 32 associated with the computer 20, or automatically by one or more drive motors under control of the computer 20.

Once the final position has been reached, the computer 20 secures the first tracking system 18 by generating signals to actuate the locking solenoids 19X, 19Y, and 19Z or other locking components, thereby locking the tracking system components and workpiece 14 in a final position. The workpiece 14 then is ready to be processed, i.e. machined, milled, lathed or graded as required. Upon completion of the processing of the workpiece 14, the workpiece holding vice 21 is released, and the finished workpiece is removed from the apparatus 10.

Those of ordinary skill in the art will recognize that the system of the present invention will facilitate accurate machining processes by providing accurate workpiece positioning. Unlike the conventional systems, the computer controlled workpiece coordinate positioning system of the present invention can check for calibration errors caused by the wear of machine parts.

For manual type embodiment, however, the machine operators can datum the workpiece in most situations and the top unit and the computer then can be withdrawn from the system. The operator can adjust the position of the workpiece by observing the displayed position information through the moving mechanism at the bottom unit. In these situations, only the positioning device 22 is required to utilize the simplicity and convenience of the present invention.

In an alternate embodiment only the positioning device 22 is utilized to provide necessary displacement and clamping of a workpiece 14, as well as required rotational movement. In a simplistic form, all movement of the positioning device 22 is manually actuated by an operator, guided by visual indications as to the position and orientation of workpiece 14 in three-dimensional space. Alternatively, the computer 20 is utilized with a plurality of displacement and rotational sensors to provide an indication on the associated display 32 as to the displacement and rotational position of the workpiece 14, or to provide for controlled movement of the positioning device 22 by actuation of one or more drive motors.

Further, it will be recognized by those of ordinary skill in the art that the individual components of the present invention may be utilized individually to modify existing machines. The computer 20 can be preprogrammed in such a way that once the workpiece 14 is positioned, the computer 20 can direct machining to the final desired end product, i.e., it can convert an ordinary general-purpose machine into a CNC center. For example, the positioning device 22 may be utilized independently of the tracking device 13, to provide a suitable positioning system for any conventional machining operation where controlled positioning of a workpiece is required. In this manner, the computer 20 can be utilized to enhance the capability of a general-purpose machine by providing increased workpiece positioning abilities through control of the positioning device 22.

Portions of the present invention can be embodied in the form of computer-implemented processes and apparatuses for practicing those processes. These portions of the present invention can also be embodied in the form of computer program code containing instructions embodied in tangible media, such as floppy diskettes, CD-ROMs, hard drives, or an other computer readable storage medium, wherein, when the computer program code is loaded into an executed by a computer, the computer becomes an apparatus for practicing the invention.

Portions of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented in a general-purpose microprocessor, the computer program code segments configure the microprocessor to create specific logic circuits.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. A workpiece holding system for positioning a workpiece, comprising:
a workpiece positioning arm adapted to engage a first surface of said workpiece;
a tracking device linked to said workpiece positioning arm, said tracking device configured to measure displacement of said workpiece positioning arm in three dimensional space;
a workpiece holding vice positioned in proximity to said workpiece positioning arm, said workpiece holding vice configured to releaseably secure said workpiece relative thereto;
a positioning device secured to said workpiece holding vice, said positioning device configured to position said workpiece holding vice in two or more dimensions;
a computer in communication with said tracking device and said positioning device, said computer configured to receive signals from said tracking device indicative of movement of said workpiece in three dimensions and responsive to said received signals to control said positioning device to position said workpiece at a predetermined position.

2. The workpiece holding system of claim 1 wherein said tracking device comprises:
a trackball linked to said workpiece positioning arm, said trackball configured for movement about two or more axis of rotation; and
two or more rotational sensors in engagement with said trackball, each of said rotational sensors configured to measure rotation of said trackball about an axis of rotation.

3. The workpiece holding system of claim 2 wherein said tracking device further comprises two or more locking elements, each of said locking elements configured to secure said trackball against rotational movement about an axis of rotation.

4. The workpiece holding system of claim 3 wherein each of said locking elements comprises a locking solenoid adapted to releasably apply a holding force to said trackball.

5. The workpiece holding system of claim 1 wherein said tracking device comprises:
a cylinder linked to said workpiece positioning arm, said cylinder configured for movement about at least axis of rotation, said cylinder further configured for movement along at least one axis;
at least one rotational sensor in engagement with said cylinder, said rotational sensor configured to measure rotation of said cylinder about an axis of rotation; and
at least one displacement sensor in engagement with said cylinder, said displacement sensor configured to measure displacement of said cylinder along an axis.

6. The workpiece holding system of claim 1 wherein said workpiece holding device is a mechanical vice adapted to engage a surface of said workpiece.

7. The workpiece holding system of claim 1 wherein said workpiece holding device is a magnetorheological fluid workpiece holding device adapted to surround a portion of said workpiece with a variable viscosity magnetorheological fluid.

8. The workpiece holding system of claim 1 wherein said positioning device comprises:
a trackball secured to said workpiece holding device; and
two or more drive motors in engagement with said trackball, each of said drive motors configured to rotate said trackball about an associated axis of rotation.

9. The workpiece holding system of claim 1 wherein said workpiece positioning arm is further adapted for reversible movement along an axis towards said workpiece holding vice.

10. The workpiece holding system of claim 1 further including a multi-points datum device positioned in operative proximity to said workpiece holding arm, said multi-points datum device configured to provide at least one position and orientation reference point for said workpiece.

11. The workpiece holding system of claim 1 wherein said positioning device comprises:
a rotational table having a surface configured for rotational movement about a first axis;
a cylindrical platform mounted on said surface, said platform configured for rotational movement of more than 180 degrees about a second axis, said second axis perpendicular to said first axis; and
a base configured to receive said workpiece holding device, said base mounted on said cylindrical platform and said base further configured for rotational movement about a third axis perpendicular to said second axis.

12. The workpiece holding system of claim 11 wherein said base is further configured for lateral movement in a plane parallel to said second axis.

13. The workpiece holding system of claim 11 wherein said positioning device is mounted on an X-Y motion system configured for planar movement perpendicular to said first axis.

14. A workpiece positioning system comprising:
a rotational table having a surface configured for controlled rotational movement about a first axis;
a cylindrical platform mounted on said surface, said platform configured for controlled rotational movement about a second axis, said second axis perpendicular to said first axis; and
a base configured to receive a workpiece holding device, said base mounted on said cylindrical platform and said base further configured for controlled rotational movement about a third axis perpendicular to said second axis.

15. The workpiece positioning system of claim 14 wherein said base is further configured for controlled planar movement parallel to said second axis.

16. The workpiece positioning system of claim 14 wherein said positioning device is mounted on an X-Y motion system configured for controlled planar movement perpendicular to said first axis.

17. The workpiece positioning system of claim 14 further including:
a first rotational sensor configured to generate a signal representative of a rotational position of said rotational table about said first axis;
a second rotational sensor configured to generate a signal representative of a rotational position of said cylindrical platform about said second axis; and
a third rotational sensor configured to generate a signal representative of a rotational position of said base about said third axis.

18. A method for controlling the position and orientation of a workpiece during machining operations, comprising:
securing said workpiece to a tracking device adapted to measure displacement in three dimensional space of said workpiece.
establishing a reference position and orientation for said workpiece;
adjusting a position and orientation of said workpiece to correspond to said established reference position and orientation;
clamping said workpiece in a holding vice;
observing changes in the displacement of said workpiece from said reference orientation resulting from said clamping step;
altering the three dimensional position and orientation of said holding vice to compensate for said observed changes in the displacement of said workpiece from said reference position and orientation.

19. The method of claim 18 for controlling the position and orientation of a workpiece further including the step of securing said workpiece at said established reference position and orientation.

20. The method of claim 19 for controlling the position and orientation of a workpiece wherein said step of securing comprise includes reversibly fixing said tracking device at a predetermined position and orientation.
